(19) United States
(12) Patent Application Publication
(10) Pub. No.: US 2016/0292457 A1
(43) Pub. Date: Oct. 6, 2016

(54) Method for Insertion of Privacy Services into Web Pages that Collect Personal Information

(71) Applicants: Peter Bodorik, Halifax (CA); Dawn Natalie Jutla, Halifax (CA)

(72) Inventors: Peter Bodorik, Halifax (CA); Dawn Natalie Jutla, Halifax (CA)

(21) Appl. No.: 14/678,933

(22) Filed: Apr. 4, 2015

(51) Int. Cl. G06F 21/62; H04L 29/06; G06F 21/10; H04L 29/08

(52) U.S. Cl. CPC G06F 21/6263; H04L 67/02; H04L 67/306; H04L 67/42; G06F 21/10; G06F 2221/0717

(57) ABSTRACT

An approach for modifying a web page, which uses a form or forms to collect private data from the user, to insert into the web page source code instructions to invoke multiplicity of web services for privacy purposes prior to the delivery of the page to the client browser and for delivery of privacy related information to the server's of the organization that is using the form to collect private data from the user. As one example, instructions are inserted into the web page source code to invoke a web service to show notice to the user that private data will be collected and seek consent from the user on the collection and use of private data. As another example, instructions are inserted into the web page source code to invoke a web service to authenticate the user. As another example, instructions are inserted into the web page source code to invoke a web service to ensure that communication with the client requesting the page is over a secure communication channel. As another example, instructions are inserted into the web page source code to invoke a web service to ensure that private data collected from the client user are de-identified. As another example, instructions are inserted into the web page sources code to invoke a web service that delivers the consent from the user on collection of private data to the servers of the organization that is using the web page to collect the private data. As another example, instructions are inserted into the web page source code to invoke multiplicity of web services that perform privacy functions and, furthermore, that a web service, that is invoked due to insertion of instructions by the method of invention, may perform a multiplicity of privacy functions—it may: ensure that communication with the client system is over a secure communication channel; and/or authenticate the client user; and/or show notice to the client user that private data will be collected; and/or obtain consent from the user for collection of private data; and/or de-identify particular private data elements. As one example of application of the proposed method, the page modified by the method of invention replaces the original web page and any subsequent requests by user browsers for downloads of the page, which collects private data form the user, results in downloading the page that was modified by the proposed method of invention. As another example of application of the proposed method, each time the web page, which collects private data form the user, is requested by a user browser for download of the page, the proposed method is applied on the web page and it is the modified page that is delivered to the user browser as a result of its request for the page.

### CROSS-REFERENCE TO RELATED APPLICATIONS

This application, for non-provisional patent, is for the previously filed provisional patent with application No. 61/976,609, filed on Apr. 8, 2014. Thus the benefit of the filing date of the provisional application (number 61976609) is claimed for this non-provisional patent application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### REFERENCES CITED

### U.S. Patent Documents

| Patent #s | Titles |
|---|---|
| 8,589,183 | Awaraji, et al. Nov. 19, 2013 |
| | Privacy compliant consent and data |
| | access management system and methods |
| 8,316,451 | Torres, et al. Nov. 20, 2012 |
| | Presenting privacy policy in a network |
| | environment responsive to user preference |
| 7,167,842 | Josephson, II, et al. Jan. 23, 2007 |
| | Architecture and method for operational |
| | privacy in business services |
| 8,275,632 | Awaraji, et al. Sep. 25, 2012 |
| | Privacy compliant consent and data |
| | access management system and methods |

### BACKGROUND

1. Technical Field

The present invention relates to a server exchanging messages with a client browser in which a web page collects private data from the user using a form or forms. To satisfy regulatory requirements for digital collection of private data, the server is required to provide privacy services, including showing notice on collection of private data, consent for use and distribution of private data to other entities, authenticating the user in certain situations, and securing data transfer between the client browser and the server. The method relates to modification of the web page to provide the privacy services, including those listed above.

2. Prior Art

When an organization uses a web page to collect private data from the user, legal requirements and standards require the organization to ensure that certain privacy services are provided while collecting the private data, privacy services that include, but are not limited to: provision to the user of notice that the private data will be collected; obtaining consent from the user on the collection of data and its use, on the length of retention of collected data, and on distribution of collected data; ensuring that the transfer of the private data is secure; and, if the private data is collected about a user known to the organization, authenticating the user. In prior art, these requirements are met by either (1) software developer including the required privacy services when creating the web page by utilizing the software development environment; or (2) in conjunction with a third party as in (U.S. Pat. No. 8,589,183 B2), or by the web browser as in (U.S. Pat. No. 8,316,451 B2). In (1), the software developer uses the software development platform and software structures prepared in it. In (U.S. Pat. No. 8,589,183 B2), the user informs the third party of her/his privacy preferences while data servers, as part of the delivery of the data to the client, communicate with the third party about the collection of private data from the user and the third party determines whether or not the collection of private data should proceed or whether the user should be involved in determining whether to proceed by examining the notice and making her/his decision. In (2b), the user informs her/his browser about her/his preference by specifying a notification setting. The notification setting may cause the web browser, upon retrieving a web page, to present one or more of a privacy notice or a legal notices, from a multiplicity of notices sent by the server, to the client user and involves the user in decision making on whether to proceed with the collection of her/his private data using a graphical interface.

### SUMMARY OF THE INVENTION

An approach for modifying a web page, which collects private data from the user, to include privacy services is described. As one example, the web page is modified, prior to its delivery to the client browser, to include code to invoke a web service that will retrieve from the server a notice on collection of private data. In another example, the web page is modified to include code to invoke a web service that will obtain from the user a consent on collection of private data and to store the obtained consent. In another example, the web page is modified to include code to invoke a web service that shows notice and obtains a consent and another web service to store the obtained consent.

Furthermore, a privacy specification application is presented that enables an administrative user, privacy officer, privacy engineer, or privacy steward to specify which privacy functions are to be executed by the inserted web services.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE SEVERAL VIEWS OF THE DRAWING

FIG. 1 illustrates an example network system.

FIG. 2A illustrates an example of a web page, which has not been modified by the method of invention, as rendered by a browser, and its source code.

FIG. 2B illustrates the source code of an example of a web page that has not been modified by the method of invention.

FIG. 3 illustrates an example of a process, without the method of invention, in which a client browser collects private data and invokes a web service to store the private data in a data store.

FIG. 4 illustrates an example of a source of the web page with inserted source code to invoke a web service when the form is rendered and with inserted code/script to invoke another web service when the submit button is clicked by the user.

FIG. 5 illustrates an example of a process of a client retrieving and displaying to the user a web page that has been modified by the method of invention

FIG. 6 shows an example a data structure for notices.

FIG. 7 shows an example a data structure for consents.

FIG. 8 shows an example of a data structure for information on web pages.

FIG. 9 illustrates an example of a process flow for the administrator to modify a web page using the method of invention and then replacing the original page with its modified version for any requests for the web page by a client.

FIG. 10 illustrates an example of a process for the administrator to specify which privacy services should be applied to a web page, modify the web page information, and instruct the web server to modify the web page, using the method of invention, whenever the page is retrieved by a client.

FIG. 11 illustrates an example of process flow wherein a web server uses the method of invention to insert invocation of web services to perform privacy function prior to the delivery of the page to the client browser.

FIG. 12 illustrates an example of a process of a client retrieving and displaying to the user a web page that has been modified by the method of invention to establish secure connection.

FIG. 13A illustrates an example of user interface window of the privacy specification system that is used by the privacy officer/engineer/steward to guide the insertion of invocation of privacy services into a web page.

FIG. 13B illustrates an example of user interface panel to provide for selection of web services for which the method of invention should insert instructions, into the selected page, to invoke them.

FIG. 13C illustrates an example of user interface panel to select assets for the selected web services to be invoked by the web page.

### DETAILED DESCRIPTION OF INVENTION

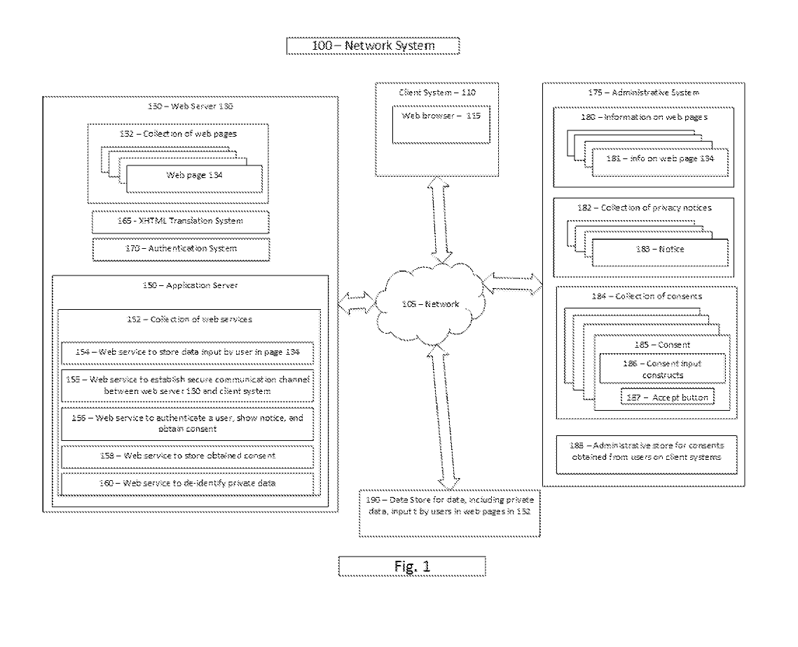

FIG. 1 illustrates a non-limiting example of a network system 100. A client system 110 may communicate with a web server 130 via a network 105. Network 105 may include one or more of a wide area network (WAN) (e.g., the Internet) and a local area network (LAN) (e.g., an intranet). As one example, client system 110 may request a web page 132 from a web server 130 via network 105. Web server 130 may return the requested web page to the client system 110 via network 105, which may be rendered by a web browser 115. The web page may have source code instructions to invoke a web service 154, hosted on an application server 150 that is used to host a collection of web services 152 that may be invoked by web pages, including web pages hosted by the web server 130. FIG. 1 shows a non-limiting example in which the application server is a system on the web server 130. In other examples, the application server 150 may be hosted on a physical platform that is different from the web server 130. Furthermore, the figure also shows that the web server also includes an authentication system 170 that can be used to authenticate users on client systems.

Web server 130 may include a collection of web pages 132 retrievable by client system 110 via network 105. The collection of web pages 132 may be referred to collectively as a web site. A web page is written in one of the scripting languages used to describe source code of the web page; languages include, but are not limited to various versions of HTML, XHTML, ASPX, and PHP. Some of the languages, including XHTML, ASPX, and PHP, require processing by a HTML page generation system that translates the source code to HTML—such web pages may be referred to as dynamic web pages. FIG. 1 shows a web server that may include XHTML translation subsystem 165.

FIG. 1 also shows administrative system 175 used by an administrator to specify and manage privacy services. The administrator may be referred to as a privacy officer/engineer/steward/administrator. Administrative system 175 may contain information on web pages 180. It may also include a collection of privacy notices 182, a collection of consents 184 that may be used to obtain consents for obtaining private data from client users, and administrative store 188 to store obtained consents from client users for web pages to collect private data.

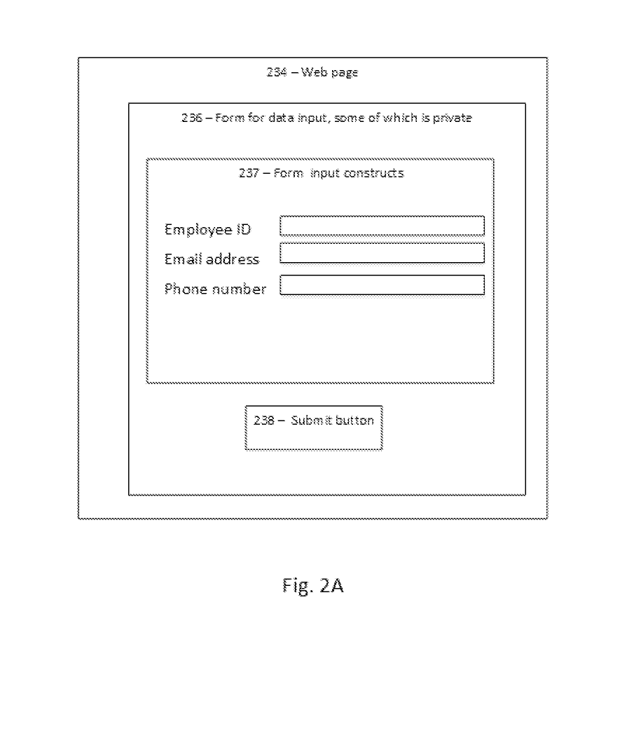

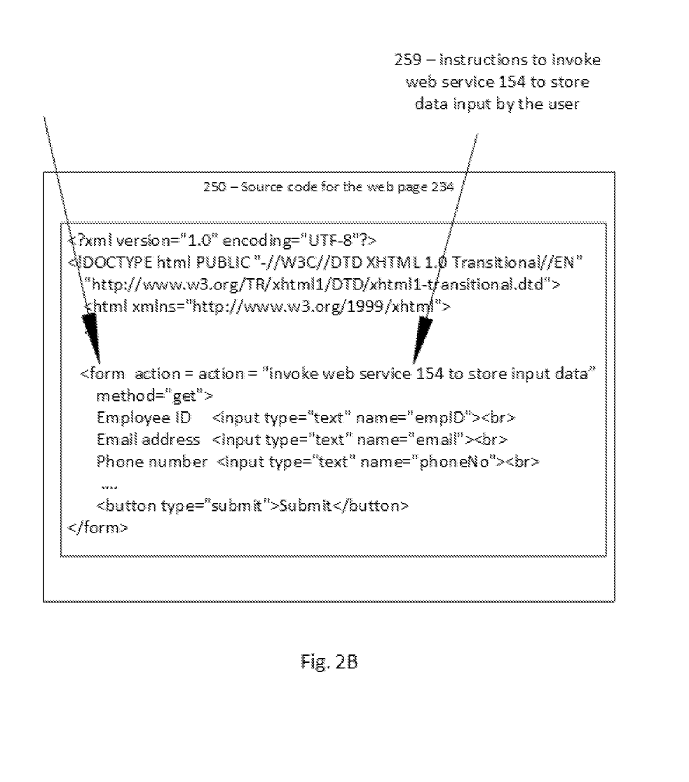

FIG. 2A shows a non-limiting example of a web page 234, as may be rendered by a browser that may collect private data from the user using a form 236 before it is modified by the method of invention. The form has a collection 237 of input constructs, input fields with labels in the example, to collect private data from the user. The form also has a submit button 238 that is clicked by the user when he/she is finished with data input and the data is to be transferred to the organization requesting the data through the form. FIG. 2B shows a non-limiting example of the source code 250 for the rendered web page of FIG. 2A. The form may be identified by a tag 256. The form may include a collection of source code statements describing input constructs 237 as rendered by the browser, input fields in the example, to collect private data from the user. The source code 257 of the form also has a sequence of instructions 259 to be executed when the submit button 238 is clicked by the user when he/she is finished with data input. The source code sequence of instructions 259 is prepared by the web page developer to specify, in this non-limiting example the invocation of a web service to deliver data, input by the user, to a server. When the web service is executed, it stores its parameters, data input by the user, in a data store.

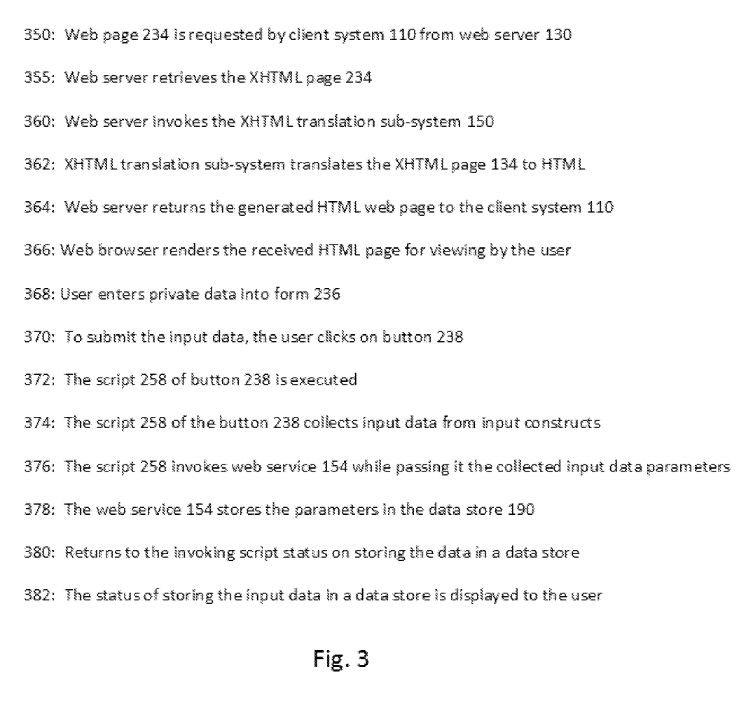

FIG. 3 shows a non-limiting example of a process, without the method of invention, in which a web page 234, of the collection of web pages that may be written XHTML, may be requested at 350 by the client system 110 from web server 130. At 355, the web server retrieves the XHTML page 234 and invokes at 360 the XHTML translation sub-system 165 that translates, at 362, the XHTML page to HTML and then it returns the generated HTML web page, at 364, to the client system 110, wherein the web browser at 366 renders the page for viewing by the user. The page may include a form 236 with input fields in which at 368 the user enters data, some of which may be private. When the user is done with input, at 370 he/she clicks on the submit button 238 of the form 236. When the button is clicked, at 376 instructions associated with the submission of form's data are executed that results: at 374 in collecting the input data from the input fields of the form; at 376 invocation of the web service 154 on the application server 150, wherein the collected input data is passed as parameters of the web service. At 378, the web service 154 stores the parameters in a data store 190. At 380, the web service returns to the invoking script a message indicating successful storage of input data and, at 382, the instructions display the status to the user.

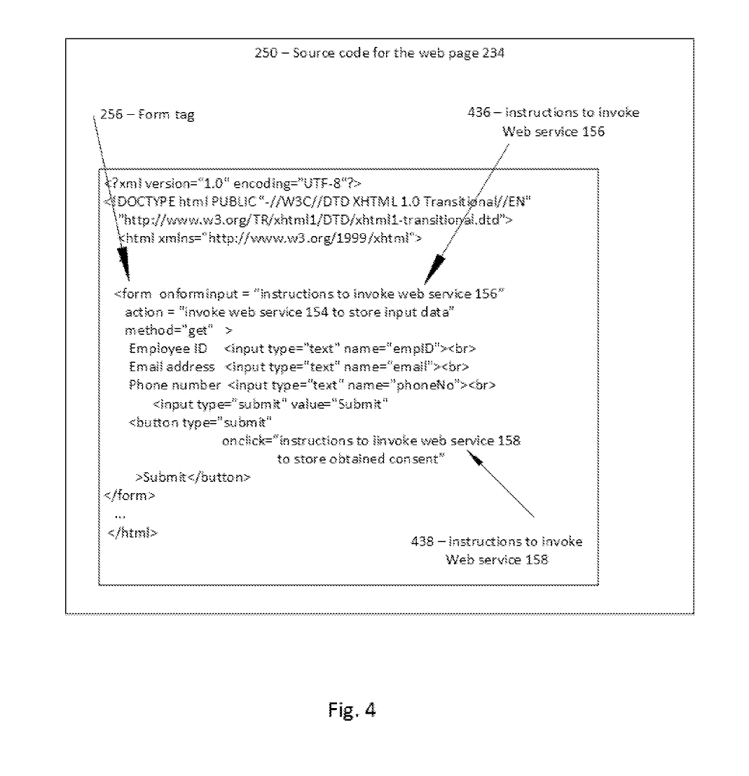

FIG. 4 shows a non-limiting example of a source code for a web page 234, used in example of figures FIG. 2A and FIG. 2B after it is modified by the method of invention. FIG. 4 shows a sequence of source code instructions 436 that may be inserted by the method of invention for action when the form 236, identified by tag 256, is rendered by a browser. The method of invention may also insert a sequence of instructions 438, at the beginning of the sequence of instructions 259 to be executed for the action of the submit button 258. The sequence of instructions 436 may include instructions 479 to invoke execution of a web service 156, on action specified for first input of by the user in the form 236, and pass it a parameter that identifies the web page 234 (in which the form is located). The sequence of instructions 438, inserted by the method of invention, may invoke a web service 158 and pass it as parameters data retrieved from the hidden fields of the page 234. It may also pass as parameters of the web service, the web page 234 identification and also identifications of the notice 184 and consent 185. The web service 158 may store the parameters in a data store 188 of a server.

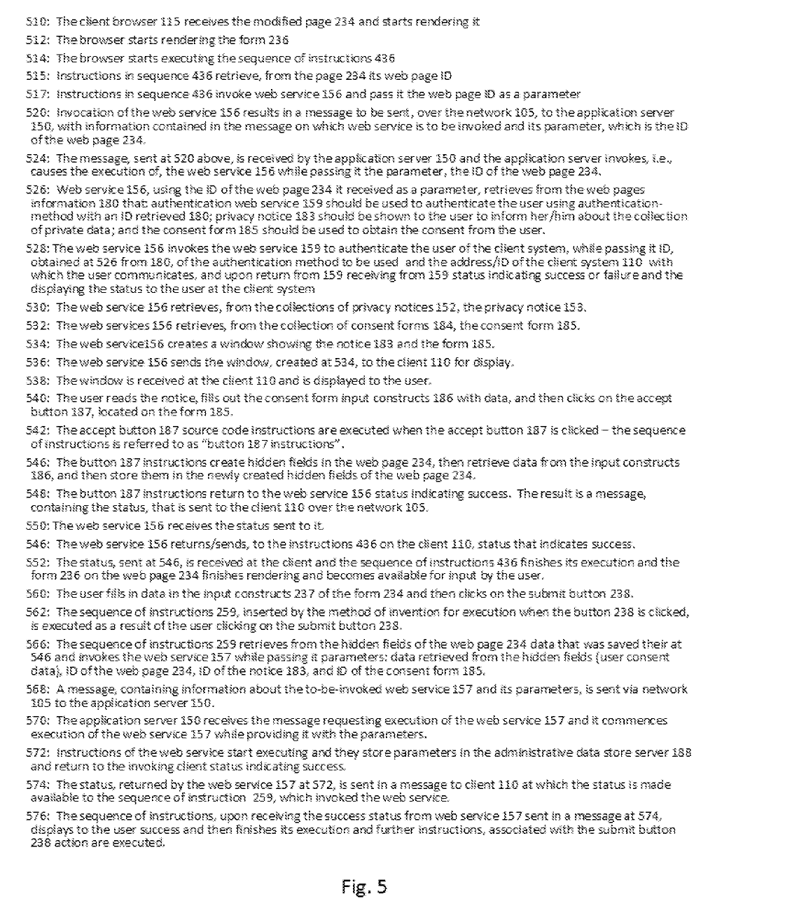

FIG. 5 shows a non-limiting example of a process of displaying to the user a web page that has been modified by the method of invention to insert source code instructions that may cause invocation of two web services as described in FIG. 4. In FIG. 5, at 510 the client browser 115 receives the modified page. At 512, the browser starts rendering the form and therefore at 514 it starts executing sequence of instructions 436, inserted by the method of invention. The inserted instructions may invoke a web service 156 that performs a multiplicity of private functions: establish secure communication with the client, authenticate the user, show notice, and obtain consent. As a non-limiting example we only describe authentication, showing notice, and obtaining consent. At 515, the sequence of instructions 436 executes and obtains the web page 234 identification and uses it, at 517, as a parameter when invoking web service 156. At 520, invocation of the web service causes sending of a message to the application server 150, wherein the message contains identification of the web service 156 and also the web service input parameter, the ID of the web page 234. At 524, the message is received by the application server 150 and it invokes the requested web service 156 and passes it the parameters contained in the message. The web service 156 is executed and its execution may cause retrieval, from the web page information structure 180 of the privacy administration store 175, using the web page 234 ID, information about the web page 234—information that may state that the user at client 110, viewing the web page 234, should be authenticated, shown a privacy notice, and give a consent for collection of private data. At 526, the web service 156 uses the ID of the web page 234, received as a parameter, to retrieve, from the web pages information 180, information on which privacy services should be used; it may retrieve information from 180 that: authentication service 159 should be used to authenticate the user using authentication-method ID; that privacy notice 183 should be shown to the user to inform her/him about the collection of private data; and that the consent form 185 should be used to obtain the consent from the user.

At 528, the web service 156 invokes the web service 159 to authenticate the user of the client system, while passing it ID, obtained at 526 from 180, of the authentication method to be used and the address/ID of the client system 110 with which the user communicates, and upon return from 159 receiving from 159 status indicating success or failure and the displaying the status to the user at the client system.

At 530, the web service 156 retrieves, from the collections of privacy notices 152, the privacy notice 153. At 532, the web services retrieves, from the collection of consent forms 184, the consent form 185. At 534, the web service156 creates a window showing the notice 183 and the form 185. At 536, the web service 156 sends the window to the client 110 for display. At 538, the window is received at the client 110 and is displayed to the user. At 540 the user reads the notice, fills out the consent form input constructs 186 with data, and then clicks on the accept button 187, located on the form 185. At 542, the accept button 187 source code instructions, executed when the accept button 187 is clicked, are executed. When the accept button 187 source code instructions are executed they: at 546 create hidden fields in the web page 234, retrieve data from the input constructs 186 and store them in the newly created hidden fields of the web page 234; and at 548 return to the web service 156 status indicating success. The result is a message, containing the status, that is sent to the client 110 over the network 105.

At 550, the web service 156 receives the status sent to it at 546 and returns/sends, to the instructions 436 on the client 110, status that indicates success. At 552, the status is received at the client and the sequence of instructions 436 finishes its execution and the form 236 on the web page 234 finishes rendering and becomes available for input by the user.

At 560, the user fills in data in the input constructs 237 of the form 234 and then clicks on the submit button 238. At 562, the sequence of instructions 259, inserted by the method of invention for execution when the button 238 is clicked, is executed as a result of the user clicking on the submit button 238. At 566, the sequence of instructions 259 retrieves from the hidden fields of the web page 234 data that was saved their at 546 (i.e., the consent data input by the user) and invokes the web service 157 while passing it parameters: data retrieved from the hidden fields (user consent data), ID of the web page 234, ID of the notice 183, and ID of the consent form 185. At 568, a message, containing information about the to-be-invoked web service 157 and its parameters, is sent via network 105 to the application server 150.

At 570, the application server 150 receives the message requesting execution of the web service 157 and it commences execution of the web service 157 while providing it with the parameters. At 572 instructions of the web service start executing and they store parameters in the administrative data store server 188 and return to the invoking client status indicating success. At 574, the status returned by the web service 157 is sent in a message to client 110 at which the status is made available to the sequence of instruction 259, which invoked the web service. At 576, the sequence of instructions, upon receiving the success status from web service 157, displays to the user success and then finishes its execution and further instructions, associated with the submit button 238 action are executed.

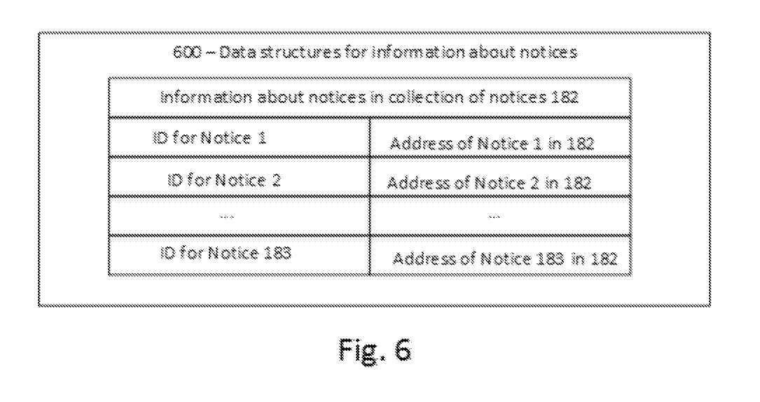

FIG. 6 shows a non-limiting example of a data structure 610 for the collection of notices information on notices 182. Notices are identified by IDs. The figure shows a data structure 160, represented as a table, that can be used to find a privacy notice given its ID. Given a notice ID for notice 183, location address is found of where the notice 183 can be found in order to be retrieved. Notices are created using some authoring tool(s).

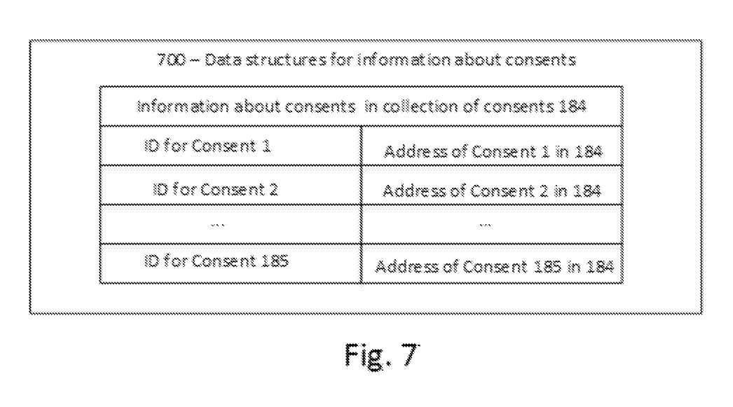

FIG. 7 shows a non-limiting example of a data structure 710 for the collection of consent forms 184. Notice forms are identified by IDs. The figure shows a data structure 710, represented as a table, that can be used to find a consent form given its ID. Given the ID for the consent form 185, location address is found of where the consent form 185 can be found in order to be retrieved. Consent forms are created using some authoring tool(s).

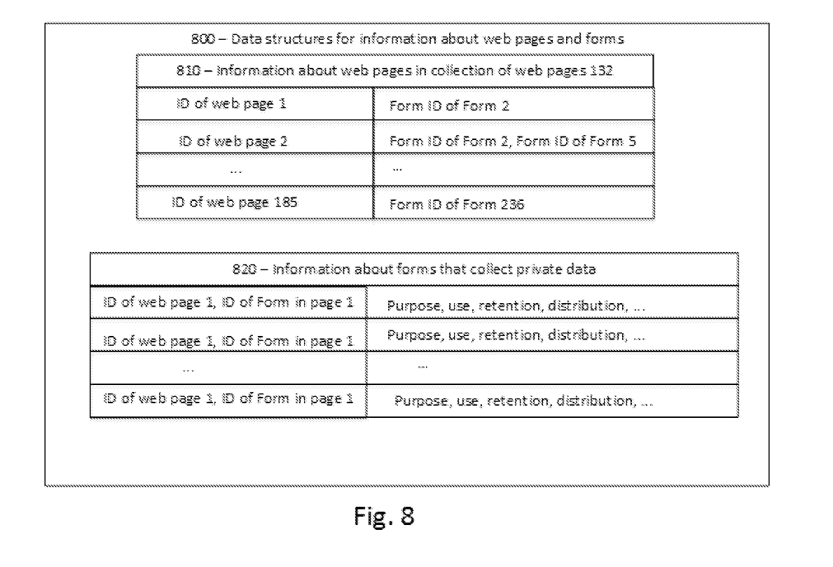

FIG. 8 shows a non-limiting example of data structures 800 used to store information about web pages. 810 is a data structure, represented as a table, that contains information on which forms are used to collect private data pages, where a page is identified by an ID or its URL. The structure is used to retrieved and update information about the web page. 820 is a data structure used to store information on forms that collect private data. For each form, the data structure stores privacy related information including, but not limited to: purpose for the collection of private data, use of private data, retention, and distribution.

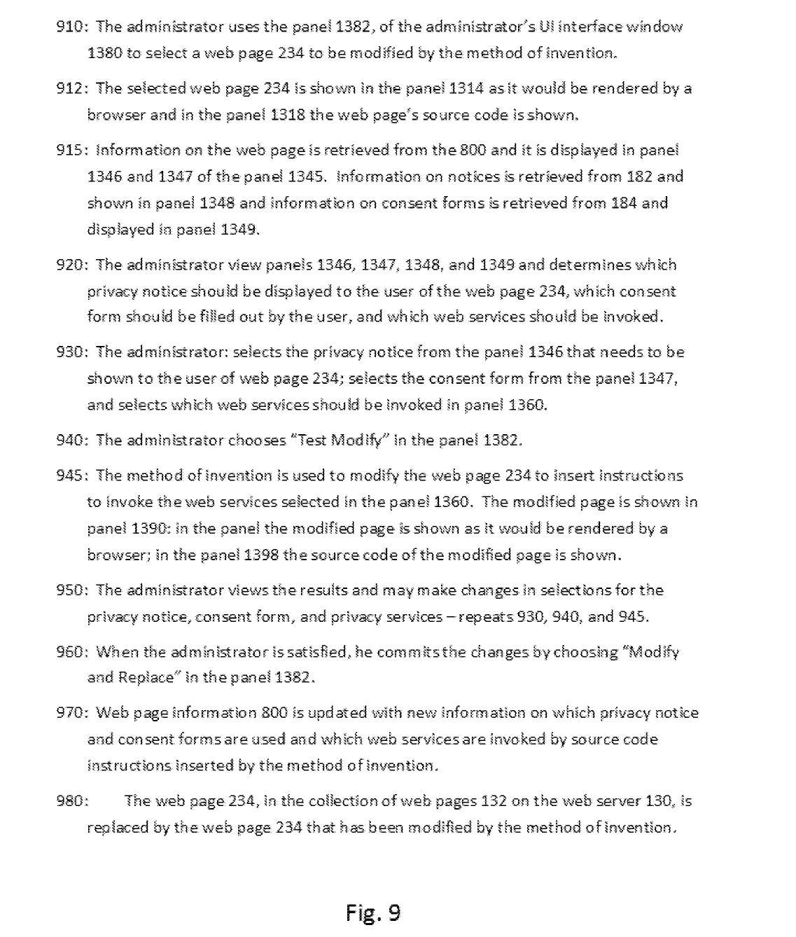

FIG. 9 illustrates a non-limiting example of a process flow for the administrator to modify a web page using the method of invention and then replacing the original page with its modified version for any requests for the web page by a client.

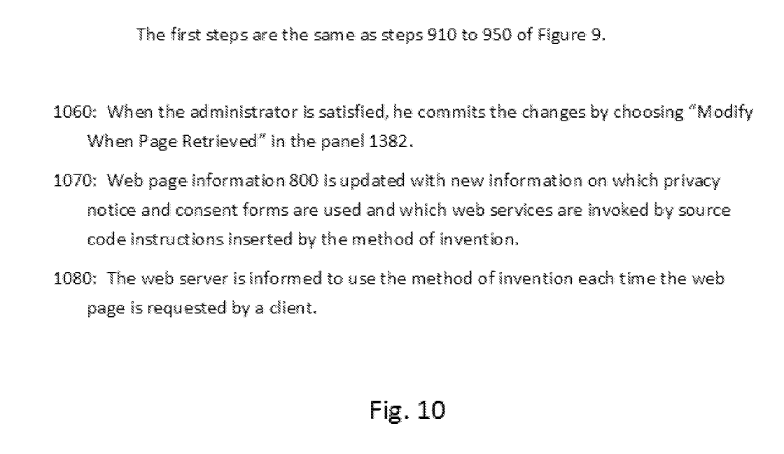

FIG. 10 illustrates a non-limiting example of a process for the administrator to specify which privacy services should be applied to a web page, modify the web page information, and instruct the web server to modify the web page, using the method of invention, whenever the page is retrieved by a client.

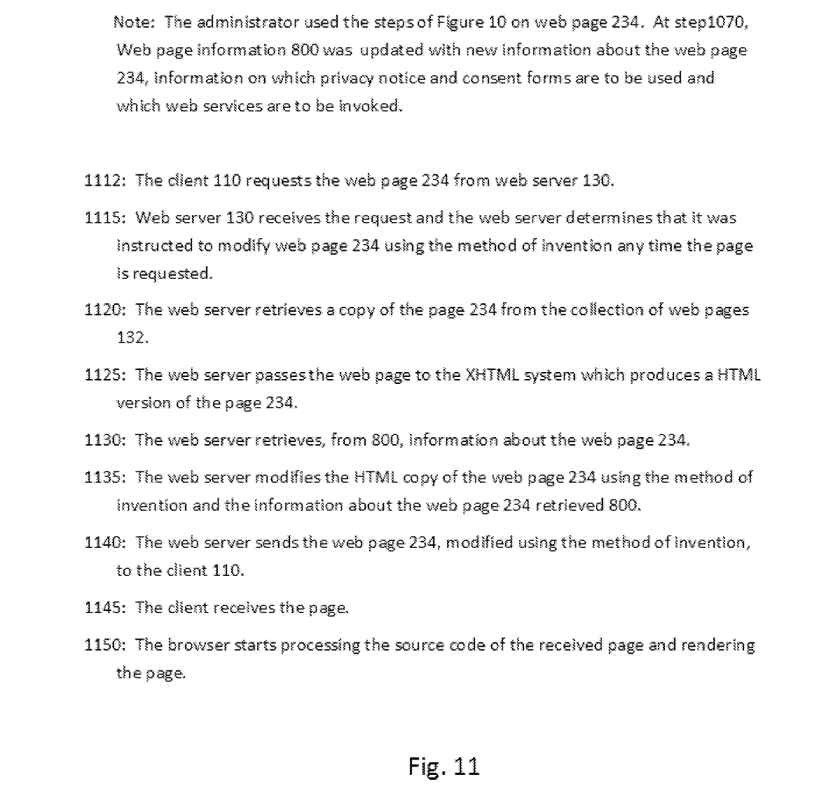

FIG. 11 illustrates an example of process flow wherein a web server uses the method of invention to insert invocation of web services to perform privacy functions prior to the delivery of the page to the client browser. The example assumes that the administrator had already used the steps of FIG. 10 on web page 234. At step1170, Web page information 800 was updated with new information about the web page 234, information on which privacy notice and consent forms are to be used and which web services are to be invoked. At 1112, the client 110 requests the web page 234 from web server 130. At 1115, the web server 130 receives the request and the web server determines that it was instructed to modify web page 234 using the method of invention any time the page is requested. At 1120, the web server retrieves a copy of the page 234 from the collection of web pages 132 and, at 1125, it passes the web page to the XHTML system which produces a HTML version of the page 234. At 1130, the web server retrieves, from 800, information about the web page 234 and, at 1135, the web server modifies the HTML copy of the web page 234 using the method of invention and the information about the web page 234 retrieved 800. At 1140, the web server sends the web page 234, modified using the method of invention, to the client 110. At 1145, the client receives the page and at 1150, the browser starts processing the source code of the received page and rendering the page.

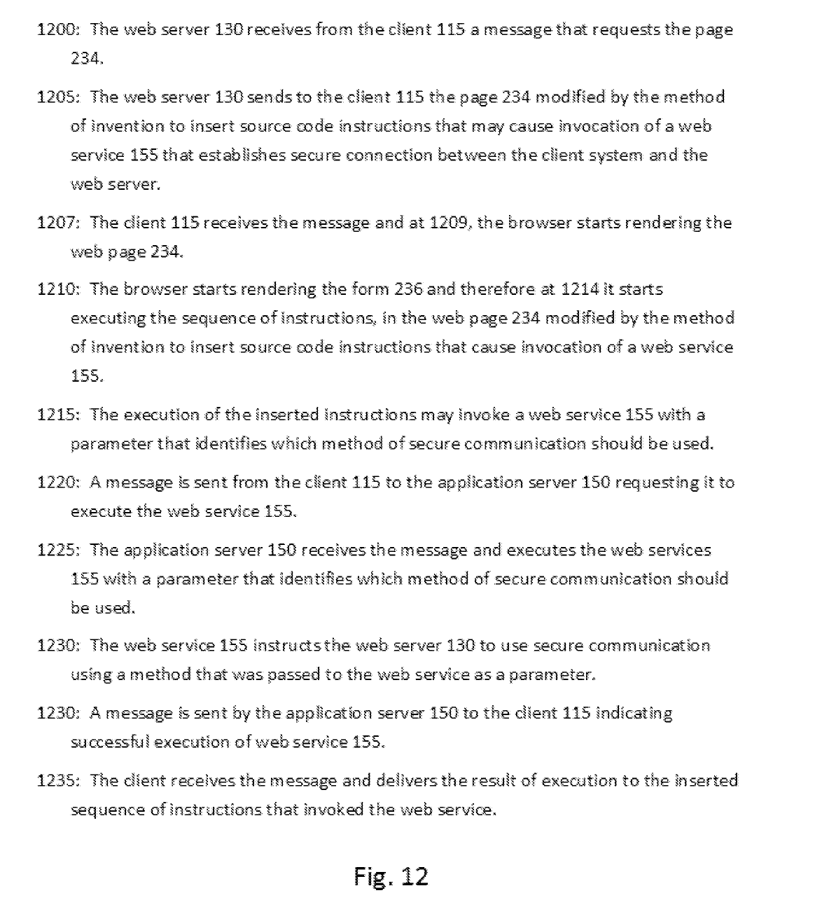

FIG. 12 shows a non-limiting example of a process of displaying to the user a web page that has been modified by the method of invention to insert source code instructions that may cause invocation of a web service that establishes secure connection between the client system and the web server. At 1200 the web server 130 receives from the client 115 a message that requests the page 234. At 1205, the web server 130 sends to the client 115 the page 234 modified by the method of invention to insert source code instructions that may cause invocation of a web service 155 that establishes secure connection between the client system and the web server. At 1207, the client 115 receives the message and at 1209, the browser starts rendering the web page 234. At 1210, the browser starts rendering the form 236 and therefore at 1214 it starts executing the sequence of instructions, in the web page 234 modified by the method of invention to insert source code instructions that cause invocation of a web service 155. At 1215, the execution of the inserted instructions may invoke a web service 155 with a parameter that identifies which method of secure communication should be used. At 1220, a message is sent from the client 115 to the application server 150 requesting it to execute the web service 155. At 1225, the application server executes the web services 155 with a parameter that identifies which method of secure communication should be used. At 1230, the web service 155 instructs the web server 130 to use secure communication using a method that was passed to the web service as a parameter. At 1230, a message is sent by the application server 150 to the client 115 indicating successful execution of web service 155. At 1235, the client receives the message and delivers the result of execution to the inserted sequence of instructions that invoked the web service.

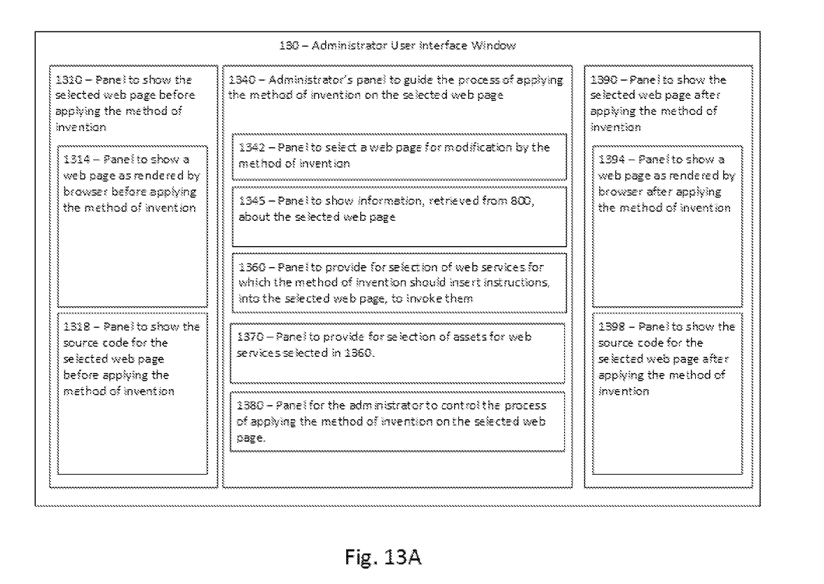

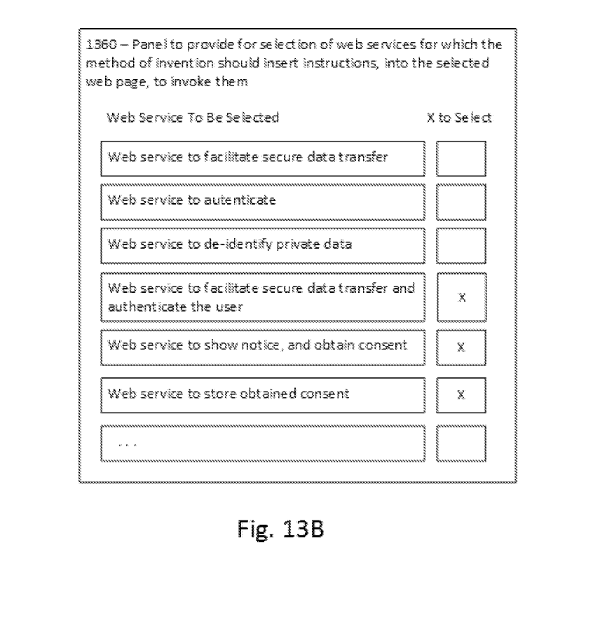

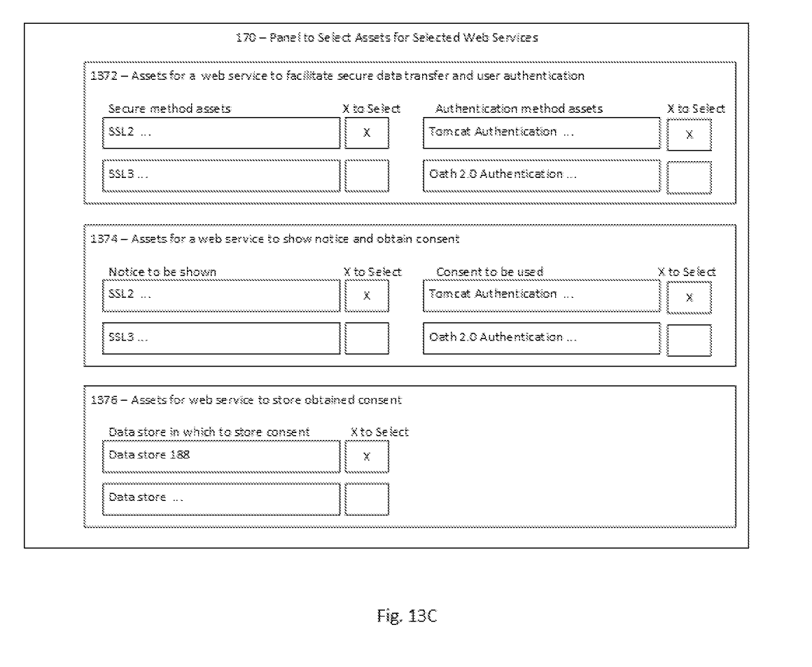

FIG. 13A, FIG. 13B, and FIG. 13C show a non-limiting example of an administrator's user interface window 1300 that may be used by the administrator, who may be performing the role of a privacy engineer/officer/steward, to use the method of invention by guiding the insertion of the source code instructions to invoke privacy service(s) into a web page. FIG. 13A shows that the window 1300 may include four panels 1310, 1310, 1390. The panel 1310 may have within it panels 1314 and 1318. Panel 1314 may show the web page 234, as it would be rendered by a browser before modification by the method of invention. Panel 1318 may show the web page 234 source code before modification by the method of invention. Panel 1390 may have within it panels 1394 and 1398. Panel 1394 may show the web page 234 as it would be rendered by a browser after modification of the web page 234 by the method of invention. Panel 1398 may show the web page 234 source code after modification by the method of invention. Panel 1340 may have within it a number of panels. Panel 1340 may have a panel 1342 that is used by the administrator to select the web page that is to be modified by the method of invention. Panel 1340 may have a panel 1345 that provides information on the web page 234 as obtained from the web page information structure 180. Panel 1340 may have a panel 1360 that provides for selection of privacy services that are to be invoked from the web page 234 by instructions that are to be inserted by the method of invention. Panel 1340 may contain panel 1370 that contains further panels, one for each of the privacy services selected by the user in the panel 1360. Panel 1340 may have a panel 1380 that is used by the administrator to guide the process of modification of a web page by the method of invention.

As other examples of the user interface, instead of one window 1300 with three panels, three separate windows may be used, one for each of the panels 1310, 1320, and 1390. As further examples, instead of panels, windows may contain other windows or combinations of windows and panels.

FIG. 13B, shows a non-limiting example of the panel 1360 in which the administrator selects which privacy web services are to be invoked on the selected web page 234 by using the method of invention to insert into the web page 234 source code instructions to invoke the selected web services. The figure shows that administrator has selected: a web service for secure transfer and authentication; a web service to show privacy notice and obtain consent; and a web service to store the obtained consent in a data store. FIG. 13C shows panel 1370. For each of the selected web services a separate panel is shown within the panel 1370. Panel 1370 contains panels 1372, 1374, and 1376: Panel 1372 shows assets for the web service to secure transfer and authentication; panel 1374 shows assets for the web service that shows notice and obtains consent; and panel 1376 shows assets for the web service that stores obtained consent in a data store. Each web service may use specific assets, from a collection of assets for the specific web service, selected by the administrator using the interface. Which assets are available for each web services is retrieved from corresponding data structures. FIG. 13C, shows an example in which the administrator has selected: in the panel 1372 secure data transfer was chosen using SSL2 (and not SSL3) and authentication using Tomcat authentication method (and not Oath 2.0); in the panel 1374, notice 183 and consent 185 were chosen; in panel 1376, data store 188 was chosen for storage of obtained consent (and not some other consent data store).

Once the web page is selected, for modification by the method of invention, by the administrator using the panel 1342, the selected web page is shown in the panel 1314 as rendered by a browser prior to the modification by the method of invention. In the examples used herein, the page selected by the administrator is web page 234. The source code of the selected page, page 234 in the examples, prior to the modification by the method of invention, is shown in the panel 1318. Panel 1380 may contain a button, labeled as “Test Modify” in FIG. 13A, that, if clicked by the administrator, uses the method of invention to insert source code into the selected web page 24. The inserted source code causes invocation of the web services selected by the administrator in the panel 1340. The web page 234, as rendered by a browser after the modification by the method of invention, is shown in panel 1394 while the source code of the web page 234, after the modification by the method of invention, is shown in the panel 1398. The panel 1380 may contain two buttons, one labeled as “Modify and Replace Page” while the other labeled as “Modify Page When Retrieved”. One or the other is clicked by the administrator, after the administrator has already clicked on the Test Modify button, observed the results of modifications by the method of invention, and the administrator is ready to commit the modifications. When either of the “Modify and Replace Page” or “Modify Page When Retrieved” buttons are clicked, information about which web services are invoked by the web page is stored in the web page information data structures 180. Furthermore, if the “Modify and Replace Page” is clicked by the administrator, the original web page 234 is replaced with the page modified by the method of invention and from that point for any request for the page 234, it is the modified page that is delivered to the requestor as the modified web page replaced the original one in the collection of web pages 132. If the “Modify Page When Retrieved” is selected by the administrator, the web server is instructed that any request for the web page 234 must be served by: first retrieving the web page 234, then retrieving information from the web page information structure 180 that informs the web server which modifications to the web page are to be performed, and then using the method of inventions, modify the web page to insert into it source code instructions to invoke web services as specified by information retrieved from 180, and only then send the modified web page to the requesting client.

1. A method of inserting into a web page, which collects private data from the client user using a form or forms on a web page, invocation of multiplicity of web services for privacy purposes, the method comprising: examining the web page for the presence of a form that collects data from the user, modifying the web page to invoke multiplicity of web services, when user first uses a form that collects private data, for privacy functions including, but not restricted to, showing to the user private notice, showing to the user legal notice, presenting consent options, collection of consent and storage of consent within the form, authentication; and examining a form, which collects private data from the user, for input construct including but not restricted to a shown button on the form that is used to submit the data collected by the form by delivery to a server, and modifying the script associated with the input construct to invoke multiplicity of web services for privacy purposes including, but not restricted to, secure data transfer, de-identification of specified personal data elements input using the form, and optional delivery of the consent obtained from the user to a server delivery of consent obtained from the user to a server.

2. The method of claim 2, where the result of the modification of the web page is used to replace the original page that has been modified resulting in any requests for the page by clients in delivery of the modified page.

3. The method of claim 2, where modification is performed by the web server each time the page is requested by a client browser just before the delivery of the page to the client browser.
